(19) United States
(12) Patent Application Publication
(10) Pub. No.: US 2007/0229296 A1
(43) Pub. Date: Oct. 4, 2007

(54) Lanyard with device for playing prerecorded sounds

(76) Inventors: Anthony J. Kohrman, Grabil, IN (US); Michael K. Betts, Fort Wayne, IN (US)

Correspondence Address: LAW OFFICES OF BRIAN C. PAULS, 919 SOUTH HARRISON STREET, SUITE 320, FORT WAYNE, IN, 46802, US

(21) Appl. No.: 11/716,858

(22) Filed: Mar. 12, 2007

Related U.S. Application Data
(60) Provisional application No. 60/782,400, filed on Mar. 15, 2006.

(51) Int. Cl. G08B 25/08; G06F 17/00; G08B 23/00

(52) U.S. Cl. 340/692; 235/375; 340/573.1

(57) ABSTRACT

An apparatus for playing pre-recorded audio data. The apparatus includes a loop of material wearable around a user's neck. The loop supports a housing and an attachment mechanism for suspending an object therefrom. The apparatus also includes a digital memory adapted to store digital audio data, at least one sound generating device and an electrical circuit operably coupling the digital memory and sound generating device whereby audio data stored on the digital memory is reproducible by the sound generating device. The digital memory and at least a portion of the electrical circuit are disposed in the housing. The housing is stably locatable at a position spaced from the attachment mechanism when the loop of material is positioned around the neck of a person with the attachment mechanism being suspended at a lowermost position of the loop of material. A method of using such apparatus to distribute information is also disclosed.

### CROSS-REFERENCE TO RELATED APPLICATIONS

This application claims priority under 35 U.S.C. 119(e) of U.S. provisional patent application Ser. No. 60/782,400 filed on Mar. 15, 2006 entitled LANYARD WITH INTEGRAL DEVICE FOR PLAYING PRERECORDED SOUNDS the disclosure of which is hereby incorporated herein by reference.

### BACKGROUND OF THE INVENTION

1. Field of the Invention

The present invention relates to the use of pre-recorded audio messages and, more particularly but not exclusively, to a lanyard supported device for reproducing pre-recorded audio messages that is adapted for use at a trade show or convention.

2. Description of the Related Art

Tradeshows, conventions, organization sponsored events and similar venues are widely used to promote goods and services and distribute information to significant numbers of people at a common physical location. Typically, the individual attendees at such events must register with the sponsoring organization. The sponsoring organization typically collects contact information from the attendees and, for some venues, may also collect an attendance fee.

To ensure that all of the attendees have registered and/or paid the attendance fee, it is quite common for the sponsoring organization to hand out badges or tags to the attendees to designate that they have registered and/or paid the entrance fee. It is quite common for the badges or tags to be supported by a lanyard or similar loop of material that can be placed around the neck of the attendee so that the badge is supported by the lanyard and displayed on the chest of the attendee.

### SUMMARY OF THE INVENTION

The present invention provides an inexpensive device that can be integrated with a lanyard and play a pre-recorded message. This device is particularly well-suited for use at tradeshows, conventions and similar events where it can be used to promote the goods of an organization participating in the event or provide information useful to an attendee of the event.

The invention comprises, in one form thereof, an apparatus for playing pre-recorded audio data that is wearable around a user's neck. The apparatus includes a loop of material and an attachment mechanism supported on the loop of material which is adapted to secure an object such as a badge thereto. A housing is also supported on the loop of material. The apparatus also includes a digital memory adapted to store digital audio data, at least one sound generating device and an electrical circuit operably coupling the digital memory and the sound generating device whereby audio data stored on the digital memory is reproducible by the sound generating device. The digital memory and at least a portion of the electrical circuit are disposed in the housing. The housing is stably locatable at a position spaced from the attachment mechanism when the loop of material is positioned around the neck of a person with the attachment mechanism being suspended at a lowermost position of the loop of material.

The invention comprises, in another form thereof, a method of distributing information. The method includes providing a plurality of disposable lanyard assemblies wherein each of the lanyard assemblies includes a loop of material adapted to be worn about the neck of a user. Each of the lanyard assemblies further includes a housing supported on the loop of material, a digital memory adapted to store digital audio data, at least one sound generating device and an electrical circuit operably coupling the digital memory and the sound generating device whereby audio data stored on the digital memory is reproducible by the sound generating device. The digital memory and at least a portion of the electrical circuit are disposed in the housing. The method also includes storing the information as audio data on the digital memory of each of the plurality of lanyard assemblies, attaching a badge to each of the plurality of lanyard assemblies wherein the loop of material of each of the lanyard assemblies is positionable around the neck of a user with the badge being suspended at a lowermost position of the loop of material and the housing being spaced from the badge, and providing the plurality of lanyard assemblies to a corresponding plurality of users.

The method may also include an organizer collecting payment from a sponsor in return for providing the plurality of lanyard assemblies and wherein audio data approved by the sponsor is stored on the digital memory of each of the plurality of lanyard assemblies.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view of a lanyard in accordance with the present invention.

FIG. 2 is a side view of the audio component housing of the embodiment of FIG. 1.

FIG. 3 is a top view of the audio component housing of the embodiment of FIG. 1.

FIG. 4 is a schematic perspective view of the embodiment of FIG. 1 in use.

FIG. 5 is a top view of the audio component housing of a second embodiment.

FIG. 6 is a top view of the audio component housing of a third embodiment.

FIG. 7 is a view of a fourth embodiment having a speaker.

FIG. 8 is a view of a fifth embodiment having an LCD screen.

FIG. 9 is a view of a sixth embodiment displaying the logo of a sponsor.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE INVENTION

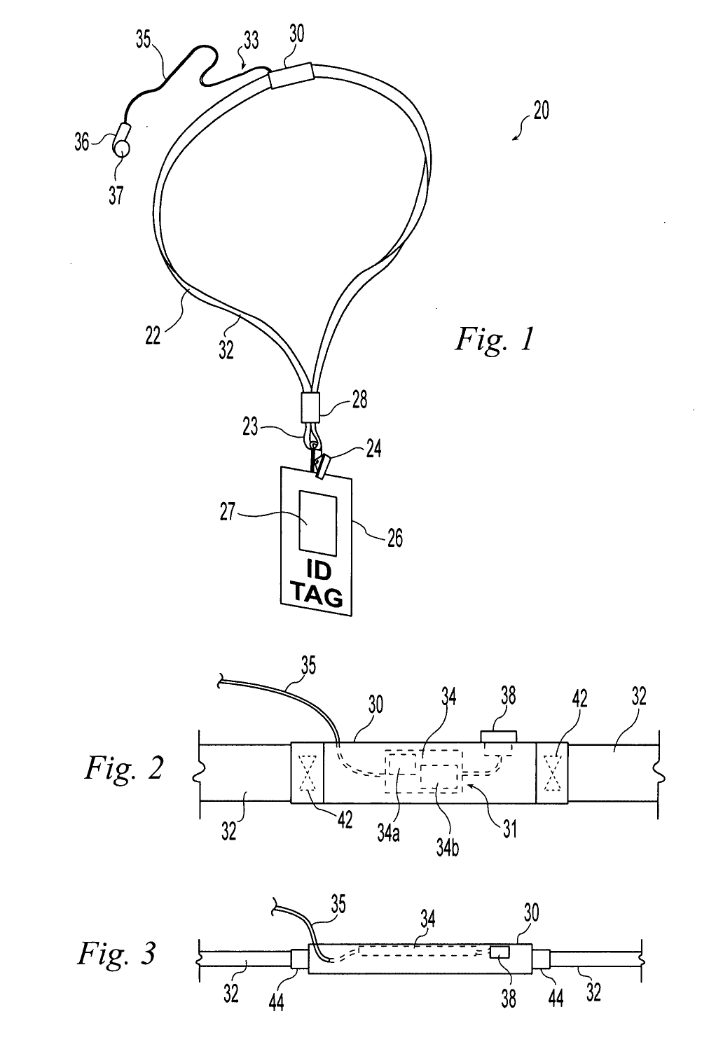

An apparatus 20 taking the form of a lanyard assembly having an audio playback device in accordance with the present invention is shown in FIG. 1. Lanyard assembly 20 includes a flexible loop of material 22 that can be placed around a user's neck to thereby support lanyard assembly 20 on the user. An attachment mechanism 24 is supported by the loop of material 22 and can be used to secure an identification badge 26 or similar item to lanyard assembly 20. In the illustrated embodiment, audio device housing 30 is located in the loop of material 22 generally opposite attachment mechanism 24. As a result, housing 30 will be located proximate the back of the user's neck when loop 22 is placed around the user's neck.

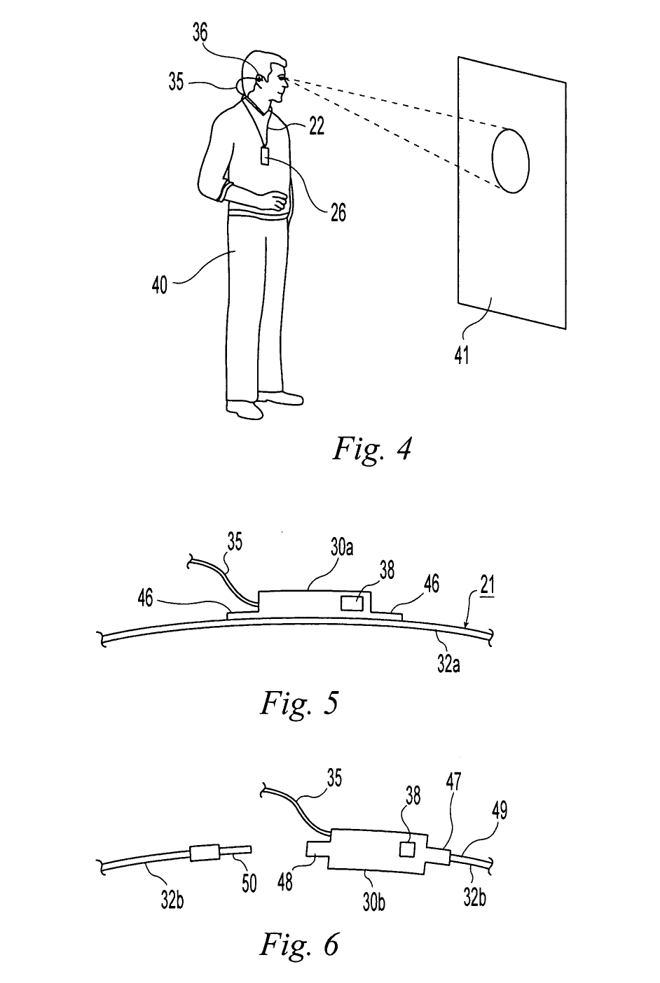

In the embodiment illustrated in FIG. 1, mechanism 24 is a spring biased metal clip that is retained on material loop 22 at a desired location by metal clasp 28 that secures together two portions of material loop 22. The use of clasp 28 retains mechanism 24 within a small section 23 of loop 22, in alternative embodiments, however, clasp 28 can be omitted and mechanism 24 can be allowed to slide along the length of loop 22. In such an alternative embodiment, the light weight of audio device housing 30 and its contents allow audio device housing 30 to be stably located at a position spaced from mechanism 24 when mechanism 24 is suspended at the lowermost portion of loop 22 as exemplified in FIG. 4. In other words, housing 30 is sufficiently lightweight that it will not necessarily cause loop 22 to slide on the user's neck to reposition housing 30 at the lowermost portion of loop 22 as the user is walking or undertaking similar non-strenuous movements due to the weight of housing 30.

In the illustrated embodiment, material loop 22 includes a length of fabric material 32 that is joined at opposite ends to housing 30. Fabric material 32, clasp 28 and attachment mechanism 24 are items that are commonly used to form a conventional lanyard for supporting an identification tag or other badge around a user's neck. Conventional lanyards for supporting identification tags utilize a variety of different materials and mechanisms to form material loops and attachment mechanisms for securing badges and similar objects to the loop of material and alternative embodiments of the present invention may utilize such alternative materials and mechanisms when forming loop 22 and support mechanism 24.

Unlike conventional lanyards used with identification tags, lanyard assembly 20 includes an audio device housing 30. Solid state electronics 34 are located within housing 30 and include a digital memory 34a and an electrical circuit 34b which operably couples digital memory 34a and a sound generating device 36. Digital memory 34a may take the form of an EPROM memory for storing a high quality audio recording of between 30 seconds and five minutes. Although it is anticipated that audio recordings of approximately five minutes will be sufficient for most uses of apparatus 20, increasing the size of digital memory 34a would allow a longer recording to be used with apparatus 20.

Actuator 38 is coupled to electronics 34 via a microcontroller and is used to activate a pre-recorded audio message stored in digital memory 34a. A flexible conductive line 35 leads from electronics 34 to sound generating device 36. A small battery located within housing 30 provides electrical power for the device.

The design of electronics 34 suitable for device 20 is known to those having ordinary skill in the art. In one embodiment, electronics 34 could take the form of a CMOS-based device such as those sold under the brand name ChipCorder® by Information Storage Devices, Inc. having a place of business in San Jose, Calif. A microcontroller is operably coupled with actuator 38 and the ChipCorder® device whereby actuator 38 controls the playing of the recorded audio data. A suitable microcontroller can be obtained from Microchip Technology Inc. having a place of business in Chandler, Ariz.

In the embodiment illustrated in FIG. 1, sound generating device 36 is a single earbud which is used to reproduce the audio recording in a conventional manner. Earbud 36 is supported on the ear of user 40 by inserting distal portion 37 into the opening of the user's ear canal. Apparatus 20 includes only a single earbud 36 to minimize the cost of device 20. Alternative embodiments of apparatus 20, however, might employ any number of other sound generating devices, e.g., the use of two earbuds, a conventional headphone set with a pair of earphones attached together with a curvilinear support member that is adapted to rest on top of the user's head, or speakers which broadcast sounds into the surrounding environment at a distance from the user's ear.

Apparatus 20 does not have the high-fidelity reproduction of musical recordings as its primary function. Instead, apparatus 20 is primarily intended to reproduce short duration audio recordings which have an informational content. A single earbud should typically be sufficient for such short duration, informational recordings.

When apparatus 20 is used to reproduce a short duration audio recording, such as a promotional message for attendees at a tradeshow, and it is expected that apparatus 20 will be discarded after only one or a few days use, the ability to inexpensively manufacture apparatus 20 is significant advantage.

Accordingly, in the illustrated embodiment, earbud line 35 is non-detachably coupled to electronics 34 and there is no output port on apparatus 20 into which a headphone seat or conventional set of earbuds could be plugged. The omission of a headphone jack on apparatus 20 and a corresponding plug on earbud line 35 facilitates the cost-efficient manufacture of apparatus 20.

Another aspect of apparatus 20 that facilitates its cost-efficient manufacture is the use of conventional identification tag lanyard materials to form a material loop 32 without any electrically conductive elements running therethrough. By using a audio device located in housing 30 that is self-contained and does not require communication with another separate electronic device, such as a radio receiver or MP3 player suspended by loop 32, there is no need to run electrically conductive wires through loop 32 to connect such separate device to housing 30 or earbud 36. Moreover, since housing 30 and its contents are relatively lightweight, it can be positioned at location spaced from the lowermost position of loop 32, thereby minimizing the length of wire 35 and eliminating the possible need to run wire 35 within loop 32.

Still another aspect of apparatus 20 that facilitates its cost-efficient manufacture is that, in the illustrated embodiment, actuator 38 is the sole user-operable control and no provision is provided for changing the pre-recorded audio data stored on digital memory 34a with the functionality of user-operated actuator 38 being limited solely to activating circuit 34b to play the pre-recorded audio data stored on memory 34a. In its final assembled form, the illustrated apparatus 20 does not include any input or output ports or antennas for receiving or transmitting wireless messages and, thus, cannot communicate with other devices.

While these various cost-efficient aspects of apparatus 20 can be utilized in various combinations and remain within the scope of the present invention, one particular combination is the provision of a sound generating device that is in non-detachable communication with electrical circuit 34b wherein the entirety of electrical circuit 34b, digital memory 34a and sound generating device 36 consists of a first portion 31 located within housing 30 and a second portion 33 that is supportable on the head of user 40 and wherein apparatus 20 is uncommunicative with other electronic devices when in its final assembled form. The use of only a single earbud 36 in such a combination provides further cost advantages.

The pre-recorded audio data is stored on digital memory 34a during the manufacture of apparatus 20 using conventional methods. While a person having the necessary technological knowledge might be able to disassemble housing 30 and possibly record new audio data on memory 34a or copy the original data recorded on memory 34a, this would likely be beyond the capacity of most users and even those with the required knowledge would likely find the task relatively cumbersome. Moreover, for most uses of apparatus 20, the audio data stored on digital memory 34a will be unlikely to be of sufficient commercial value or interest to entice individuals to seek to copy such data.

Apparatus 20 is well suited for distributing an audio message concerning a product or informational display 41 at a tradeshow or similar event. When user 40 is near the display 41, the user 40 presses actuator 38 which then initiates the playback of the prerecorded audio message. Such pre-recorded messages can be used to provide information about the display. Although such pre-recorded messages can be used in cooperation with physical displays 41, such recordings may also be used to present information to user 40 without any accompanying physical display.

The housing can be attached to material loop 22 in various manners and several alternative embodiments of the housing are illustrated in the figures. Housing 30 illustrated in FIGS. 2 and 3 is formed out of a plastic material and includes receptacles 44 at each end of housing 30. The opposite ends of fabric material 32 are inserted into receptacles 44. Material 32 is secured to receptacles 44 with stitching 42 in the illustrated embodiment.

The embodiment illustrated in FIG. 5 has a housing 30a with outwardly extending tabs 46. In this embodiment, material 32a forms an uninterrupted loop and housing 30a is secured to exterior surface 21 of material 32a with adhesives or other suitable means at tabs 46.

The embodiment of FIG. 6 is similar to the embodiment of FIGS. 1-4 in that opposite ends of a length of flexible material 32 are attached to opposite ends of housing 30, 30b, instead of the housing being attached to an exterior surface of flexible material 32. More specifically, and with reference to the embodiment of FIG. 6, first and second ends 47, 48 of housing 30b are respectively attachable to third and fourth ends 49, 50 of loop of material 32b to form a closed loop.

The embodiment of FIG. 6 differs from that of FIGS. 1-4 in that the housing 30b of FIG. 6 includes a modified receptacle 48 that disengageably receives a male member 50 positioned on an end of material 32b. Member 50 can be securely engaged when inserted into receptacle 48 but will disengage when subjected to a moderate force. Such attachment devices are commonly found on lanyards used in manufacturing facilities and other locations having rotating machinery where it is undesirable to have a strong loop of material around a person's neck. Receptacle 48 and member 50 have a conventional construction for providing such a break-away connection. Housing end 47 and loop end 49 are joined together with stitching as used in the embodiment of FIGS. 1-4.

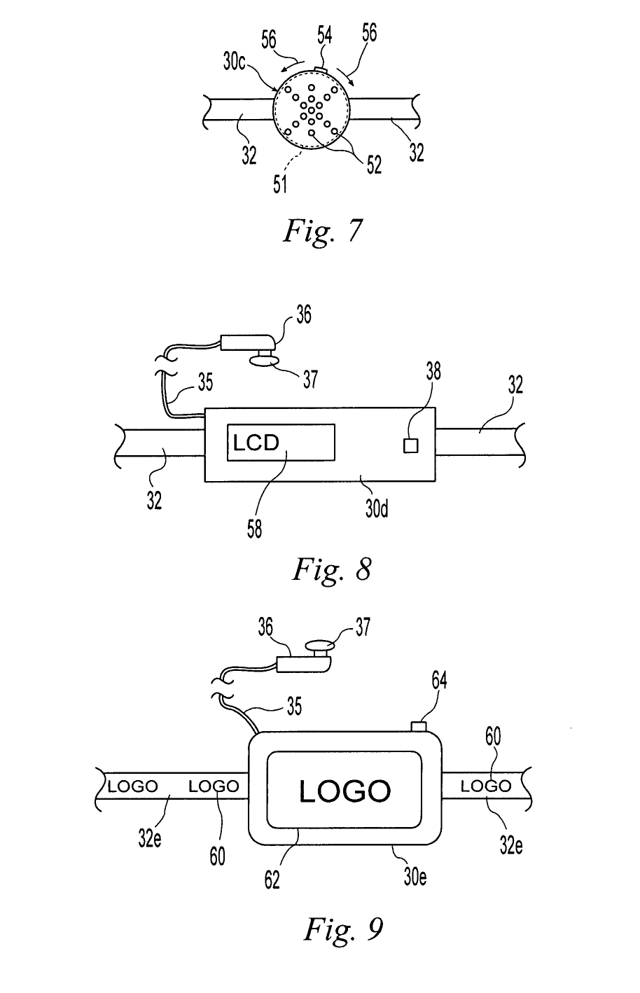

The embodiment of FIG. 7 utilizes a speaker 51 located within the housing to reproduce the audio recording instead of an earbud. Housing 30c has a plurality of speaker openings 52 to allow for the transmission of the sound generated by internal speaker 51 and a volume knob 54. The volume of speaker 51 can be adjusted by sliding knob 54 as indicated by arrows 56.

The embodiment of FIG. 8 has a housing 30d and a small alphanumeric display in the form of a liquid crystal display (LCD) screen 58. LCD screen 58 can be used to display short alphanumeric messages. For example, it may display, “listen now” when the audio recording is initiated. Such a textual display is particularly useful when the device employs an earbud to reproduce the audio message. In addition to instructions regarding the operation of device 20, LCD screen 58 may also be used for other purposes. For example, user 40 could be directed to a sponsor's website where user 40 would input an alphanumeric code displayed on LCD screen 58 for a chance to win a prize. By directing user 40 to the sponsor's website, the sponsor could also receive feedback from user 40 on the items being promoted by apparatus 20 and allow potential customers to provide their contact information to the sponsor.

The embodiment of FIG. 9 illustrates how the device can be branded by a sponsor. As shown in FIG. 9, material 32e may have the sponsor's logo 60 printed or formed thereon. The sponsor's logo could also be displayed on housing 30e. In the illustrated embodiment, logo 60 is displayed on housing 30e by affixing an adhesive label 62 thereon, however, logo 60 could alternatively be printed directly on housing 30e, physically formed in housing 30e, or otherwise displayed on housing 30e. For example, in yet another embodiment, the overall shape of the housing could conform to the shape of the sponsor's logo. The embodiment of FIG. 9 also includes a light 64. Similarly to the “listen now” message of LCD 58, light 64 can be used as a playback indicator that changes its visual appearance, e.g., activation of light 64, to indicate when the pre-recorded audio data is being played. Light 64 might also be used for some other purpose, e.g., to draw attention to device 20.

Apparatus 20 can be used in a variety of settings and for a variety of purposes. A particular useful application of apparatus 20 is to distribute information, in the form of a pre-recorded audio message stored on digital memory 34a, to attendees of a tradeshow, convention or similar event. Generally, attendees of such events must register to obtain entry to the event. This will often be the case even when there is no admittance fee charged.

It is also quite common for attendees at such events to wear a badge of some type. As used herein badge simply refers to an object, e.g., object 26, that provides some minimal information about the person associated with the badge but does not have to be specific to the user. For example, an admittance ticket placed in a plastic sleeve and which is identical to thousands of other admittance tickets would be considered a badge that designates that the person associated with the ticket is properly admitted to the event. Self-printed name tags, identification tags and various other forms of devices may also constitute badges. As depicted in FIG. 4, attendees at tradeshows are often given badges 26 that include indicia 27 of some kind indicating user 40 to be a proper attendee of the event.

When entering the event, a lanyard assembly 20 with an appropriate badge 26 can be given to each of the attendees. Often times, there is a checkpoint, registration desk or similar monitoring station, either staffed by persons or utilizing automated kiosks or similar devices, at the entry to such events where each of the attendees must verify that they have properly registered for the event. This might be done by checking the name of the attendees against a list of registered individuals, obtaining information from the individual necessary to register that person, and/or verifying that they have already obtained a badge 26 (which might have been previously mailed to them). The individuals who demonstrate that they are proper attendees of the event can be provided with a lanyard assembly 20 at this same time.

The organizer of the event providing the lanyard assemblies 20 to the attendees may offset the cost of lanyard assemblies 20 by collecting payment from a sponsor. In return, the logo of the sponsor might be printed on the lanyard assemblies 20 and the sponsor would determine what audio data would be stored on the digital memory 34a of the lanyard assemblies 20. While it is also possible to charge individual attendees for lanyard assemblies 20, it will often be more efficient and desirable to have a sponsor pay for the expense of lanyard assemblies 20 and not charge the individual attendees a separate charge for the lanyard assembly. The relatively inexpensive nature of lanyard assemblies 20 allows assemblies 20 to be single use or “disposable” devices that are given to attendees without requiring the attendees to return lanyard assemblies 20.

While this invention has been described as having an exemplary design, the present invention may be further modified within the spirit and scope of this disclosure. This application is therefore intended to cover any variations, uses, or adaptations of the invention using its general principles.

What is claimed is:

1. An apparatus for playing pre-recorded audio data and wearable around a user's neck, said apparatus comprising:
a loop of material;
an attachment mechanism supported on said loop of material and adapted to secure an object thereto;
a housing supported on said loop of material;
a digital memory adapted to store digital audio data;
at least one sound generating device;
an electrical circuit operably coupling said digital memory and said sound generating device whereby audio data stored on said digital memory is reproducible by said sound generating device, said digital memory and at least a portion of said electrical circuit being disposed in said housing; and
wherein said housing is stably locatable at a position spaced from said attachment mechanism when said loop of material is positioned around the neck of a person with the attachment mechanism being suspended at a lowermost position of said loop of material.

2. The apparatus of claim 1 wherein said attachment mechanism is confined to a predefined portion of said loop of material and said housing is affixed to said loop of material at a position spaced from said attachment mechanism.

3. The apparatus of claim 2 wherein said housing is located generally opposite said attachment mechanism on said loop of material.

4. The apparatus of claim 1 wherein said at least one sound generating device is in non-detachable communication with said electrical circuit, and wherein said electrical circuit, said digital memory and said at least one sound generating device consist of first and second portions, a first portion disposed within said housing and a second portion supportable on the head of the user, said sound generating device, said electrical circuit and said digital memory being uncommunicative with other devices when said apparatus is fully assembled.

5. The apparatus of claim 5 wherein said at least one sound generating device consists of a single sound generating device which is at least partially insertable into an ear of the user and thereby supported on the user's ear.

6. The apparatus of claim 5 wherein said loop of material consists of non-conductive materials.

7. The apparatus of claim 1 wherein said at least one sound generating device consists of a single sound generating device which is at least partially insertable into an ear of the user and thereby supported on the user's ear.

8. The apparatus of claim 1 wherein said at least one sound generating device comprises a speaker disposed in said housing.

9. The apparatus of claim 1 wherein said housing has a first end and an opposite second end, and said loop of material has a third end and an opposite fourth end, said loop of material forming a closed loop by respectively attaching said third and fourth ends of said loop of material to said first and second ends of said housing.

10. The apparatus of claim 9 wherein said fourth end of said loop of material is disengageably attachable to said second end of said housing.

11. The apparatus of claim 1 wherein said housing is affixed to an exterior surface of said loop of material.

12. The apparatus of claim 1 further comprising a user-operated actuator for activating said circuit and playing digital audio data stored on said digital memory.

13. The apparatus of claim 12 wherein said user-operated actuator provides the sole user-control feature of said apparatus and said user-operated actuator has a functional capacity limited solely to activating said circuit to play prerecorded digital audio data stored on said digital memory; and wherein said sound generating device, said electrical circuit and said digital memory are uncommunicative with other devices when said apparatus is fully assembled.

14. The apparatus of claim 1 further comprising a playback indicator, said indicator having a first visual appearance when said sound generating device is de-activated and a second visual appearance when said sound generating device is generating sound.

15. The apparatus of claim 1 further comprising an alphanumeric display.

16. A method of distributing information, said method comprising:
providing a plurality of disposable lanyard assemblies, each of the lanyard assemblies comprising a loop of material adapted to be worn about the neck of a user, each of said lanyard assemblies further comprising a housing supported on the loop of material, a digital memory adapted to store digital audio data, at least one sound generating device and an electrical circuit operably coupling the digital memory and the sound generating device whereby audio data stored on the digital memory is reproducible by the sound generating device, the digital memory and at least a portion of the electrical circuit being disposed in the housing;
storing the information as audio data on the digital memory of each of the plurality of lanyard assemblies;
attaching a badge to each of the plurality of lanyard assemblies wherein the loop of material of each of the lanyard assemblies is positionable around the neck of a user with the badge being suspended at a lowermost position of the loop of material and the housing being spaced from the badge; and
providing the plurality of lanyard assemblies to a corresponding plurality of users.

17. The method of claim 16 further comprising the step of an organizer collecting payment from a sponsor in return for providing the plurality of lanyard assemblies;
and wherein the step of storing the information includes storing audio data approved by the sponsor on the digital memory of each of the plurality of lanyard assemblies.

18. The method of claim 17 wherein the step of providing the plurality of lanyard assemblies to a corresponding plurality of users includes distributing the plurality of lanyard assemblies to attendees of an event wherein the attendees are not separately charged for the lanyard assemblies and the attendees are allowed to keep the lanyard assemblies.

19. The method of claim 18 further comprising the step of confirming that a person is a proper attendee when distributing a lanyard assembly to the person and wherein the badge includes indicia designating the wearer of the lanyard assembly as a proper attendee of the event.

20. The method of claim 16 wherein the step of attaching a badge to each of the lanyard assemblies includes attaching the badge with an attachment mechanism wherein the attachment mechanism is confined to a predefined portion of the loop of material and the housing is affixed at a position on the loop of material located substantially opposite the attachment mechanism.

21. The method of claim 20 wherein the at least one sound generating device consists of a single sound generating device at least partially insertable into an ear of a user to thereby support the sound generating device on the user's ear.
